(19) United States
(12) Patent Application Publication
(10) Pub. No.: US 2005/0289473 A1
(43) Pub. Date: Dec. 29, 2005

(54) Method and system for providing search information via a communications network

(76) Inventors: Carl Gustafson, Port Washington, NY (US); Carol Curtin, Rosedale, NY (US); Denise Petrulis, New York, NY (US); Izabella Rakhman, New York, NY (US); Jerry Ronaghan, New York, NY (US); Jim Currie, New York, NY (US); Jonathan Jaggers, Brooklyn, NY (US); Joshua Braunstein, New York, NY (US); Karen Abramson, Alpine, NJ (US); Peter Sluzhevsky, Kew Gardens, NY (US); Wayne Drummond, Somerset, NJ (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 11/040,821

(22) Filed: Jan. 21, 2005

Related U.S. Application Data
(60) Provisional application No. 60/553,897, filed on Mar. 17, 2004.

(51) Int. Cl. G06F 17/00; G06F 15/00; G06F 7/00

(52) U.S. Cl. 715/764; 707/104.1; 715/509; 715/530

(57) ABSTRACT

A system and method for electronically reviewing and utilizing a trademark search report containing a plurality of records. Users of the system can place virtual color coded tags on selected records and sort the tagged records for creating a modified report. The users can select various colors for the tags wherein each color can have a particular significance to the user reviewing the report. The user can utilize information in the report to create another document such as a trademark clearance opinion.

### CROSS-REFERENCE TO RELATED APPLICATIONS

The present application claims the benefit of U.S. Provisional Application Ser. No. 60/553,897, filed on Mar. 17, 2004, the contents of which are incorporated herein by reference.

### FEDERALLY SPONSORED RESEARCH OR DEVELOPMENT

Not applicable.

### TECHNICAL FIELD

The present invention is generally directed to a method and system for viewing and utilizing an electronic trademark search report over a network connection, and more particularly to a method and system for viewing and utilizing an electronic trademark search report stored in a remote database having a plurality of records, and for placing tags on select records in the report to enable a user to flag particular records and to filter the tagged records to create a chart or a modified report.

### BACKGROUND OF THE INVENTION

Investigating the availability of a mark (e.g., a word, design, slogan or combination thereof) to use as a trademark can involve looking at a number of sources and types of information. These include trademarks already registered on the Federal Register, as well as trademarks for which an applicant is currently seeking registration on the Federal Register; common law marks, business names, State Registrations; Domain Names etc. Typically, a person, such as an attorney, making such an investigation, orders a search of one or more of such sources, or types, of information be performed.

The search can be performed in-house at the attorney's law firm using various electronic databases, or by a professional searcher or search company contracted by the attorney. In either event, the search results are typically printed out and presented to the attorney for review in a paper format.

In many instances, the attorney reviewing the paper search results would like to use the search results to create a written clearance opinion or memo regarding the availability of the desired mark. In such cases, the attorney may wish to use the results, for example, to identify potential obstacles or problems with using the desired mark; or to establish the weaknesses of certain elements of a mark, or point to a third party's aggressiveness in opposing similar marks, etc. In this regard, the attorney may wish to flag certain items developed in the search, or create notes regarding various items during the attorney's review of the search result for later use in the opinion or memo. Additionally, the attorney may want to incorporate portions of the results—and in particular, items flagged or with notes added to them—directly into the written opinion or memo.

In order to flag certain items in the report, and/or place notes on certain items, the attorney must write directly on the results or use sticky notes or some other form of writing adhered to or kept with the report. Moreover, to include portions of the results in a written opinion or memo, the attorney must have such portions cut and pasted into the opinion or memo or retyped therein. In either case, the use of paper search results does not provide the ease and versatility associated with the typical computer applications utilized for other matters.

The present invention is provided to solve the problems discussed above and other problems, and to provide advantages and aspects not provided by prior trademark search reporting systems. A full discussion of the features and advantages of the present invention is deferred to the following detailed description, which proceeds with reference to the accompanying drawings.

### SUMMARY OF THE INVENTION

The present invention provides a system for reviewing and utilizing trademark search reports with a computer. The system and applications described herein can be utilized with a local area network (LAN) or on a single computer; however, the system is preferably utilized over the Internet. Specifically, the system includes a server computer which hosts a website accessible over the Internet. The website provides a user interface wherein a user of the system can log in, order a trademark search report for a specified mark, and review and utilize the search report when completed.

In one embodiment of the invention, a system for reviewing and manipulating an electronic trademark search report comprises a trademark search report database having at least a first trademark search report. The system preferably is accessed over the Internet by a user's browser application. Preferably, the database includes a plurality of trademark search reports (e.g., for a plurality of different orders by users of the system). The first trademark search report (as well as any other search reports) contains a plurality of trademark records uncovered by the searcher. Each trademark record contains a variety of investigative information relating to the trademark uncovered in the search that is the subject of the record. The investigative information can be broken into fields or segments in the record.

The system further includes an interface configured to allow a first user of the system to view the first trademark search report and navigate through the first trademark search report. The interface is further configured to allow the first user to place a first tag on at least a first one of the plurality of trademark records in the first trademark search report. The interface additionally allows the first user to place a second tag on a second record of the plurality of records in the report, and subsequent tags on additional records. The first tag and any other tags placed by the first user will appear to other users of the system reviewing the first trademark search report. Similarly, any tags placed by other users of the system can be viewed by the first user.

The first user can select a first color from a plurality of available colors for the first tag placed on the first one of the plurality of trademark records. The same or different colors can be selected for any subsequent tags placed on records by the first user. Each of the available colors can have a unique significance. For example, one color can indicate an exact hit with the trademark being searched (i.e., same mark for the same goods or services etc.). Another color can indicate the Registration for the mark which is the subject of the particular record has been abandoned. The remaining colors can be assigned other significance relevant to the review of a trademark search report. The system can allow the first user to change the first tag (or any other tags placed in the report) to a second color of the plurality of available colors. Moreover, the first user can change the significance assigned to each color.

Each of the trademark records in the first trademark search report provides information regarding a particular mark developed in the search. Moreover, each record can comprise one or more links to additional information relating to the trademark record at issue. Such additional information includes a design of a mark identified in the trademark record or registration information of a mark identified in the trademark record.

Each trademark record in a report comprises a plurality of record sections which correspond to the fields or segments of the investigative information for the record. The interface of the system is configured to allow a user to expand or collapse each of the plurality of record sections.

The system is preferably set up to allow multiple users access to the trademark reports. This multi-user environment allows the users to collaborate in the review process. Accordingly, the interface is further configured to allow a second user of the system (and any subsequent users) to view the first trademark search report and navigate through the first trademark search report (as well as any other reports specifically available for a particular entity or set of users in the database). In this regard, the system may limit the review of any one report to one user at a time. The second user can place a second tag on the first one of the plurality of trademark records in the first trademark report, or a first tag on other records not already tagged by the first user. Each user's tags can include the user's initials so that it is apparent which user placed a particular tag on a record in the report. The second user can also select and manipulate the color of the tags in the same manner as described above.

The interface of the system is further configured to allow the first user to place a note on the first one of the plurality of trademark records. Similarly, additional notes can be placed on other records in the report.

The interface is configured to allow a user to filter a subset of trademark records of the plurality of trademark records for display. One such filter displays only the tagged records in a report. The filter can be even more specific and only display tagged records of a particular color. The system can create a chart of the tagged records.

In another embodiment of the invention, a system including a database accessible by a user's computer over a network is provided for reviewing and utilizing trademark search reports. The system comprises a host computer or server accessible to a plurality of devices over a network (either wired and/or wireless). The host computer is coupled to one or more databases that collectively store a plurality of trademark search reports wherein each trademark search report includes a plurality of trademark records. One or more of the databases can be housed in the host computer. The host computer runs an application for generating a user interface to allow a user of the system on a remote device to select, display and navigate through the plurality of trademark search reports and the plurality of trademark records associated with each trademark search report. The user interface generates a graphical display to facilitate navigation and use by any user of the system. The user interface allows a user to place a first color coded tag on a first trademark record of the plurality of trademark records in a first trademark search report of the plurality of trademark search reports. The first user can place additional color coded tags on other records of the plurality in the first trademark search report. Additionally, the first user can generate a note associated with a record.

In accordance with another embodiment of the invention, an online electronic system for reviewing a trademark report is provided. The system and trademark report is accessible to multiple users. The system includes a server computer having a processor coupled to a database containing a first trademark report with a plurality of records. The server computer is connected to the Internet and accessible to a plurality of user computers connected to the Internet. A user interface application is support by the server computer. The user interface allows a first user through a first user computer to review the first trademark report and to place a virtual tag on a first record of the plurality of records in the first trademark report. The first user can place a second virtual tag on a second record, or additional tags on additional records. The first user can select a color for each of the tags. Subsequent users can place their own tags on any of the records and can view tags placed by prior users of the system. Similarly, the users can place and review notes associated with particular records.

In yet another embodiment of the invention, a method of electronically reviewing a trademark search report stored in a database comprises supporting a website accessible to a plurality of users over a network and maintaining a plurality of trademark search reports on a database associated with the website. The method further comprises receiving input from a first user computer of a first user of the system over the network selecting a first trademark search report containing a plurality of records and generating an electronic signal for displaying the contents of the first trademark search report on the first user computer. The method further comprises receiving input from the first user computer identifying a first record of the plurality of records in the first trademark report for placement of a first tag; and, generating a first tag for displaying in connection with the first record. The method includes receiving input from subsequent users selecting the first trademark search report or other reports and placing tags on select tags on records in the report.

The method can further include receiving input from the first user computer selecting a color of the first tag. Additionally, the method includes receiving input from the first user computer identifying a plurality of additional records from the plurality of records in the first trademark report for placement of a respective plurality of tags; filtering the plurality of records for records having tags; and, creating a chart of the filtered records.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a simplified block diagram of a system in accordance with the present invention comprising a client side and a server side having a user database;

FIG. 2 is a screen shot of an order retrieval page from the user database of FIG. 1;

FIG. 3 is a screen shot of a title page from an order selected from the order retrial page of FIG. 2;

FIG. 4 is a screen shot of a first reference page comprising a search results index and a record (i.e., a trademark record) of a federal trademark, wherein the record is provided after selecting to review the report from the title page of FIG. 3;

FIG. 5 is a screen shot of a record with a pop-up window depicting goods and services related to the record;

FIG. 6 is a screen shot of a record with a pop-up window depicting assignments related to the record;

FIG. 7 is a screen shot of a record with a pop-up window depicting trademarks with ownership similar to the record;

FIG. 8 is another screen shot of a reference page comprising a record of a state trademark that is provided by selecting the record within the search results index of the navigation panel of FIG. 4;

FIG. 9 is a screen shot of a record of a common law trademark with a pop-up window depicting the text containing the common law trademark;

FIG. 10 is a screen shot of an owner index page associated with a record in a report;

FIG. 11 is a screen shot of a database currency and search strategies page associated with a record in a report;

FIG. 12 is a screen shot of a chart of tagged records page;

FIG. 13 is a screen shot of a record in a report with additional fields and links to additional investigative information relating the record;

FIG. 14 is a screen shot of a record and a pop-up window displaying search results from a catalog search regarding whether the mark identified in the record is in use;

FIG. 15 is a screen shot of a record and a pop-up window displaying search results from a web content search regarding whether the mark identified in the record is in use;

FIG. 16 is a screen shot of a record and a pop-window displaying the TTAB history of the mark identified in the record;

FIG. 17 is a screen shot of a record with a pop-window displaying the TARR history of the mark identified in the record;

FIG. 18 is a screen shot of a record with a pop-window displaying a DUN & BRADSTREET® report on the owner of the mark identified in the record; and,

FIG. 19 is a screen shot of a record with a pop-up window displaying a website of the owner of the mark identified in the record.

### DETAILED DESCRIPTION

While this invention is susceptible of embodiments in many different forms, there is shown in the drawings and will herein be described in detail preferred embodiments of the invention with the understanding the present disclosure is to be considered as an exemplification of the principles of the invention and is not intended to limit the broad aspect of the invention to the embodiments illustrated.

The present invention is a method and system for reviewing and manipulating a trademark search report—from a plurality of search reports stored in a database—over a network connection. The invention includes the use of a host computer or server 10 having a server engine 12, one or more databases (e.g., 14 and 18) coupled to the processor in the host computer 10, and an interface application 16 which allows a user of the system to retrieve and view a trademark search report from the database(s) and to manipulate or utilize the trademark search report in a useful manner (e.g., via Internet web pages). Generally, the interface 16 allows a user of the system to place color coded tags, or flags, next to specific trademark records in a trademark search report. Trademark records in a report bearing these tags can be filtered to create a further defined trademark report. The interface also allows the user to view relevant information regarding each trademark record (either as part of the record or through a link in the record), as well as place a note on a record, or add further information to the record contents.

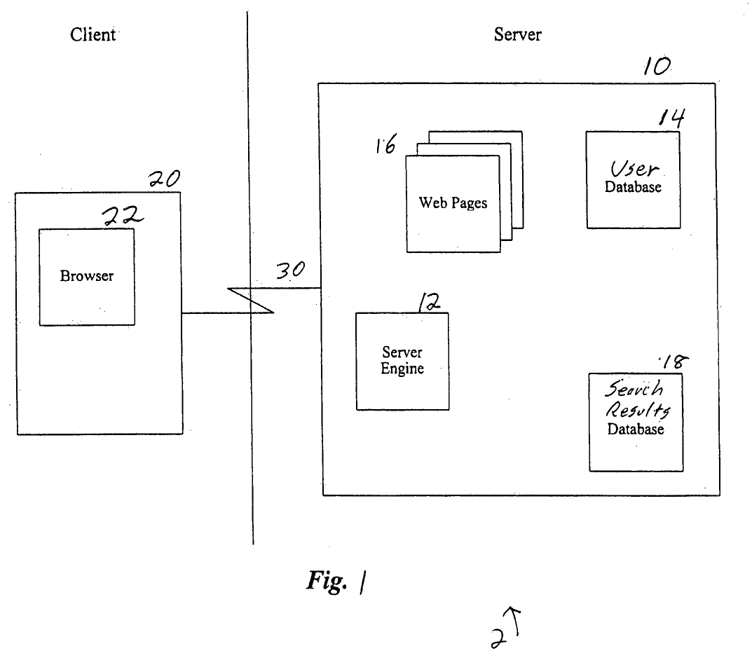

Referring to FIG. 1, the interface 16 is preferably supported on a website reached by a browser application 22 residing on a user's computer 20 connected to the Internet 30. However, it is recognized other network structures can be used with the present invention. For example, a plurality of search reports can be received, either over the Internet or via other means, such as downloaded to a system from a disk or CD, to a host computer connected to a local area network (“LAN”). In this regard, the interface can be reached by the user's computer over the LAN connection.

In the preferred form of the invention, the interface supports access by Internet Explorer 6.0 and higher. Additionally, the interface should be compatible with MS Windows 98, MS Windows 2000, MS Windows NT, MS Windows ME and MS Windows XP operating systems. Documents generated at the website during electronic review of the trademark search reports should be compatible with MS Word 2000 or higher. The documents should also be compatible with Corel Word Perfect.

The website run by the interface 16 preferably includes typical security measures, such as user login procedures which require input of a user name and a password. The system recognizes the user upon login and automatically utilize the user's initials (or other identifying data) with tags and notes as further described below.

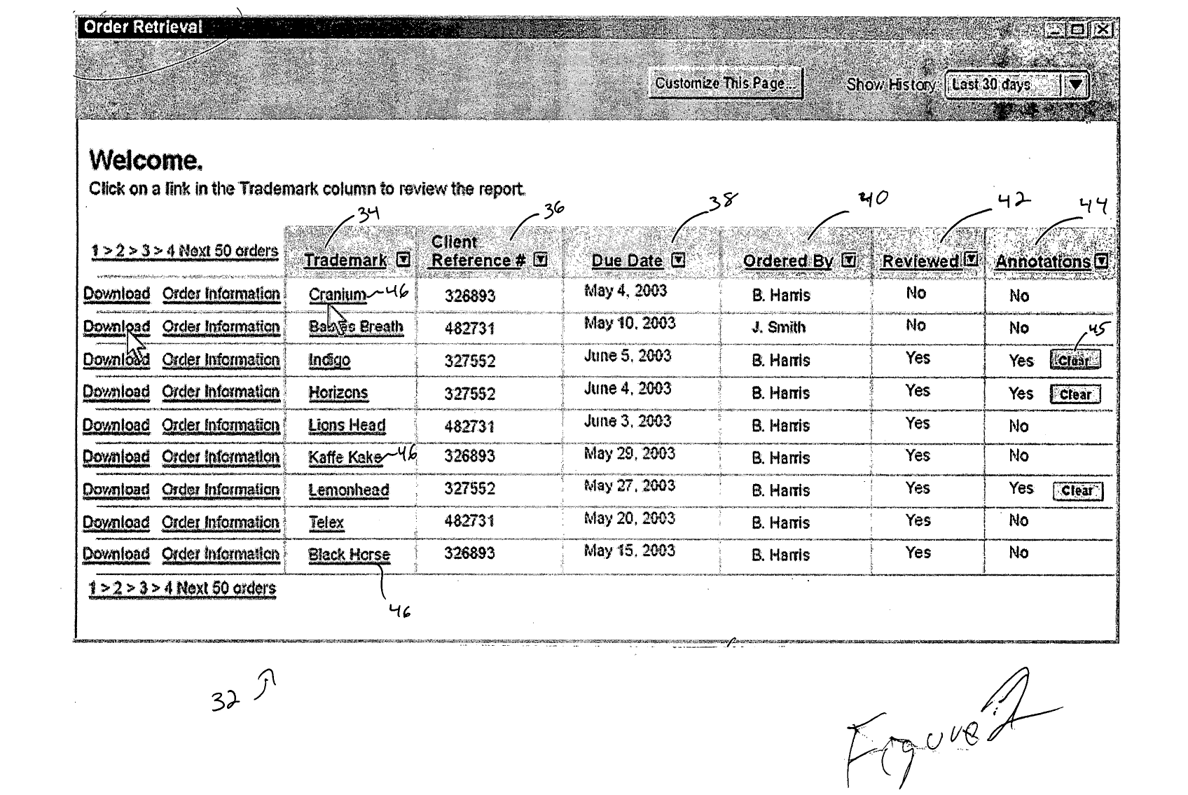

After logging in to the system 2, a user can navigate to an Order Retrieval page 32 of the interface 16 as illustrated in FIG. 2. The Order Retrieval page 32 allows the user to view the trademark search reports stored in the database 18 coupled to the system 2, and to navigate to a desired report.

The Order Retrieval page 32 includes a Trademark field 34, a Client Reference Number field 36, a Ship or Due Date field 38, an Ordered By field 40, a Reviewed field 42 and an Annotations field 44. Each of these fields 32, 34, 36, 38, 40, 42, 44 are sortable. Additionally, a user can filter the fields based on certain criteria (e.g., search reports can be filtered by time period, e.g., last 30 days, or by who ordered the reports, etc.). The system will only allow one user to review a report at one time. Any other user attempting to access an open report will receive an error message.

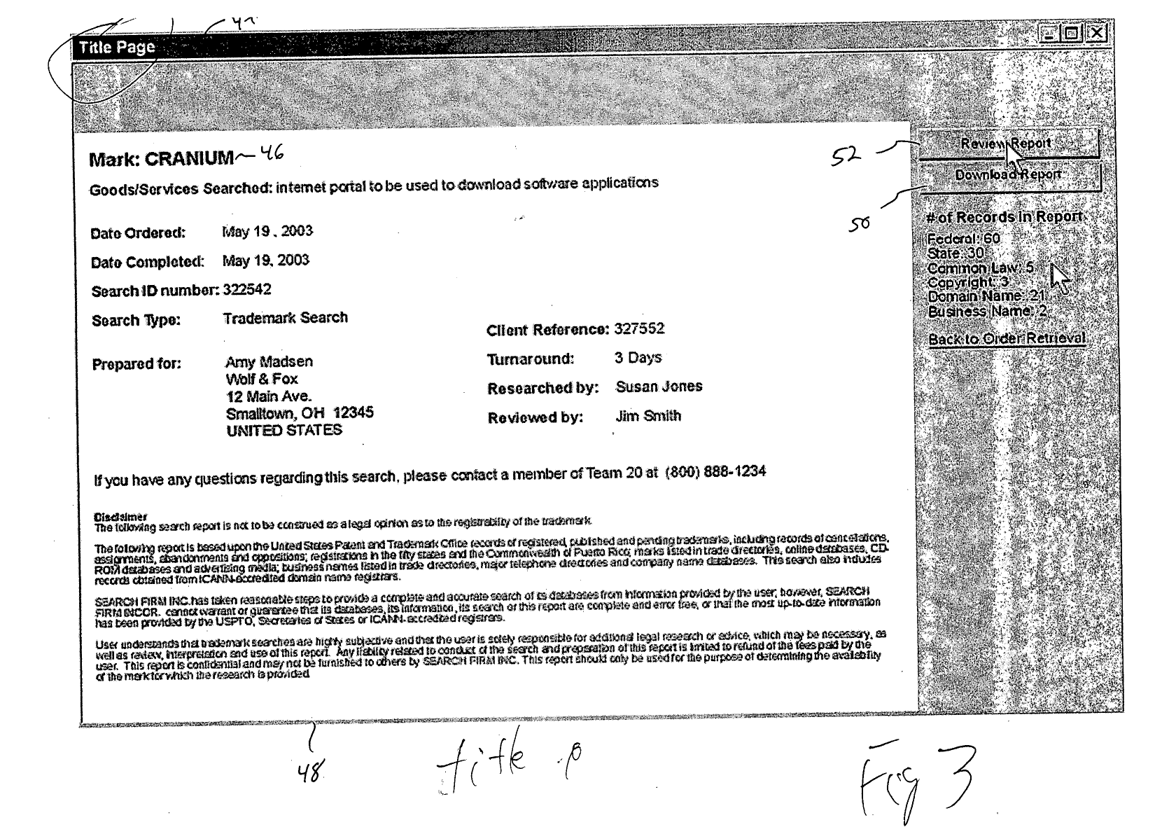

The Trademark field 34 sets forth the trademarks 46 the user (or one of multiple users from the same company or law firm) has sought trademark search reports. A trademark 46 will appear in a first color, such as blue, to indicate it is a hyperlink to a trademark search report currently available for electronic review. The trademarks 46 will appear in black if the trademark search report is not yet available. Clicking on a blue hyperlink opens the trademark search report 48 for the trademark 46 in question for access by the user. The first time the user links to a particular trademark search report 48 the user will be brought to the Title page 47 of the report 48. For example, clicking on the “CRANIUM” trademark 46 opens the Title page 47 of the trademark search report 48 for “CRANIUM” as illustrated in FIG. 3.

The Client Reference Number field 36 provides an associated client reference number for each trademark search ordered, and the Ordered By field 40 identifies a particular user (i.e., a law firm may have a plurality of attorneys ordering trademark searches on a particular account) who ordered the search report. The Due Date field 38 provides a date the search report is to be completed. The Reviewed field 42 identifies to one user of the system 2 whether another user has already reviewed the search report associated with a particular trademark 46, and the Annotations field 44 shows whether a prior user has left any notes on the report. The system 2 may allow a user to clear a report of any annotations (or other additional investigative information or tags). A “Clear” icon or link 45 can be provided for this purpose.

Once any user has accessed an electronic trademark search report 48, the search will be “frozen.” If a search report 48 is regenerated after any user accesses the report 48 the system will not regenerate the XML content associated with the report 48 unless a new order is placed.

The user has the functionality to download the report 48 to the user's computer 20 in the format the report 48 was posted in to the website of the system 2. This is quickly achieved by clicking a “Download Report” link 50 located on the Title page 47. The user can navigate the system 2 to view additional details of an Order. An “Order Information” link is provided for this purpose.

The Title page 47 (see FIG. 3) provides an overview of the report 48 for the user to familiarize himself or herself with the report 48 before starting the review process. In this regard, the Title page 47 provides certain information regarding the Order and search performed on the trademark 46 at issue. This information can include, for example, identification of the mark searched, the date of the Order, the date the Order was completed, the individual ordering the search, the individual performing the search, the requested turnaround time, the client reference number, the search type and the Order ID number, any disclaimers, etc. The Title page 47 also includes information concerning the contents of the report 48, such as the total number of records and/or the number of records per type (e.g., common law, state or Federal Registrations, Business name etc.). The user can access or link to the main portions of the report on-line by clicking on a “Review Report” link 52.

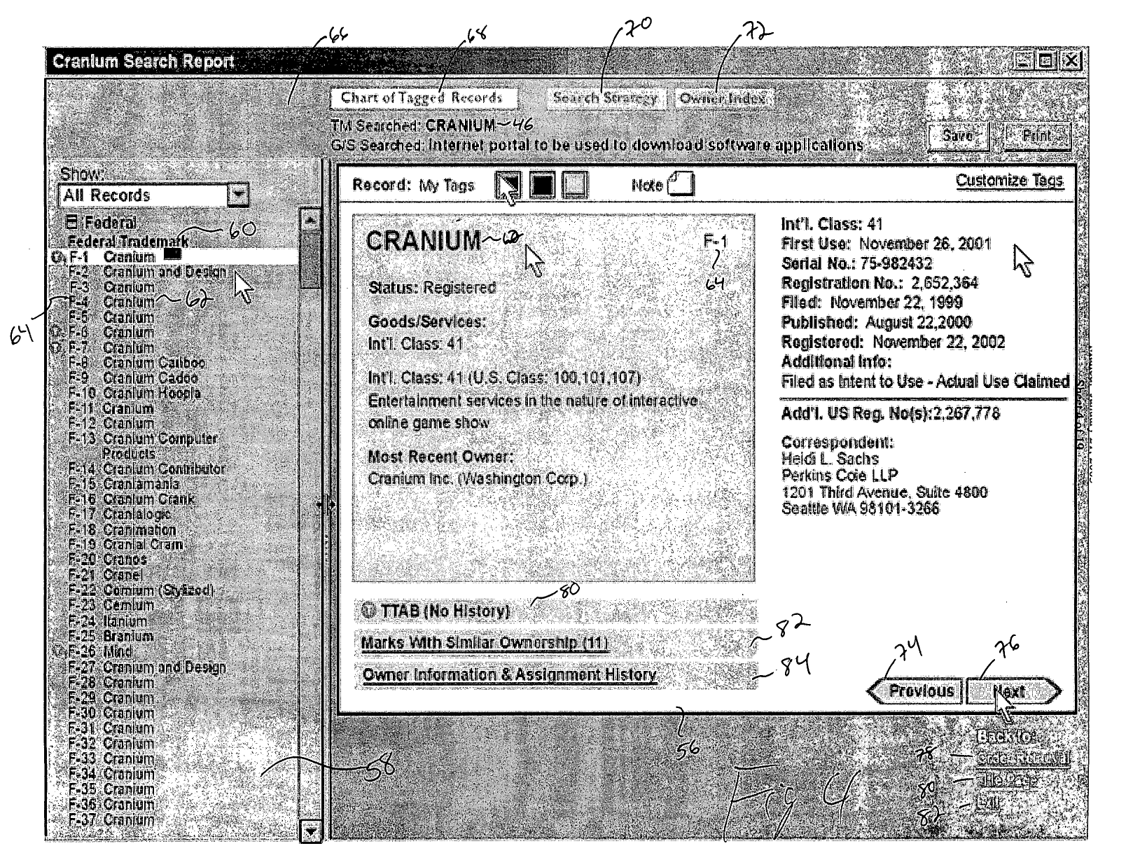

Opening the trademark report 48 from the Title page links the user to the record detail 56 of the first record or mark 62 in the report. Each mark 62 is associated with a record having a record detail that can be displayed. Accordingly, the terms “mark” (when referencing a mark reported in a search report as opposed to the mark being searched), “record” and “record detail” may be used interchangeably herein. In the present example, the trademark report 48 selected is for the mark “CRANIUM” 46 as identified on the title page 47 (this information is also displayed in the top frame of each record detail 56). The first record detail 56 of the present example identifies a Federal Registration also for the mark “CRANIUM” 62 (as illustrated in FIG. 4).

A navigation panel 58 also appears with the first record detail 56 and all subsequent record details 56 in the report 48. In the present example, the navigation panel 58 appears as a frame on the left-hand side of the user's computer screen. The navigation panel 58 provides a list 60 of all of the records 62 in the report 48. This list 60 of records 62 on the navigation panel 58 can be delineated by section (i.e., record type—such as, common law, state or Federal Registrations, etc.). The list 60 includes identification of each mark 62 developed in the search, and a reference number 64 associated with each record 62. The record 62 and reference number 64 associated with the current record detail 56 selected is highlighted in the navigation panel 58. The user can directly link to another record detail 56 through the navigation panel 58 by clicking (or double clicking) a particular mark 62 on the list 60.

The following is a non-exhaustive list of the sections (and subsections in parentheses) that can be included in one of the trademark reports of the present invention: Federal (Federal Trademark; Federal Design; Federal Ownership; Trademark Cases); State (State Trademark; State Ownership); Common Law; Copyright; Domain Name; Business Name (ABI U.S. Business Directory; Dun & Bradstreet); Corporate Name (Corporate Citations); Canada (Canadian Federal; Canadian Common Law; Canadian Business Name); Mexico; and International.

The user can filter records 62 appearing in the navigation panel 58 using pre-defined search criteria. Only records 62 fitting the selected criteria will be displayed on the navigation panel 58, and the remaining records 62 will be hidden. Such filter options include: All Records (this is the system default); Tagged Records; Untagged Records; and Active Records (i.e., records for marks which have not been abandoned, cancelled, etc.).

An upper frame 66 appears on the user's screen above the navigation panel 58 and the record detail 56 of the first record 62 (or other currently viewed record). This frame 66 includes links to a Chart of Tagged Records 68; the Search Strategy 70; and an Owner Index 72. Other possible links include a link to a Federal Classifier 122 and a Supplemental Investigative Report 124. The record detail 56 provides the user with links 74, 76 to the “previous” or “next” record 56. Additionally, links 78, 80, 82 are provided to allow the user to navigate back to the Order Retrieval page, the Title page 47 of the current report 48, or to exit the system 2. When a record 62 is selected from the navigational panel 58 or by using the previous link 74 or next link 76, the record details 56 for the selected record 62 is displayed.

The record details 56 for a specific record 62 include a variety of information or data regarding the record 62. In part, the kinds, or fields, of information provided in each record 56 will depend on the record type. For example, a record of a Federal Registration will include fields of information relating to the Federal Registration Number, the International Classification of goods, etc.; another type of record, such as a common law mark, will not include such fields, and instead may include different information not necessarily reported in a record 62 for a Federal Registration.

While each records detail 56, such as the one for the first record 62 illustrated in FIG. 4, includes relevant information relating to the mark at issue in the open window, additional information relating to that mark is provided in pop-up windows linked to the record details 56. In the example illustrated in FIG. 4, the record details 56 includes a link to any file history of the mark before the Trademark Trial and Appeal Board (TTAB) 80. In this example, the link 80 provides additional information. In this particular case, the link 80 specifically indicates “No History” exists.

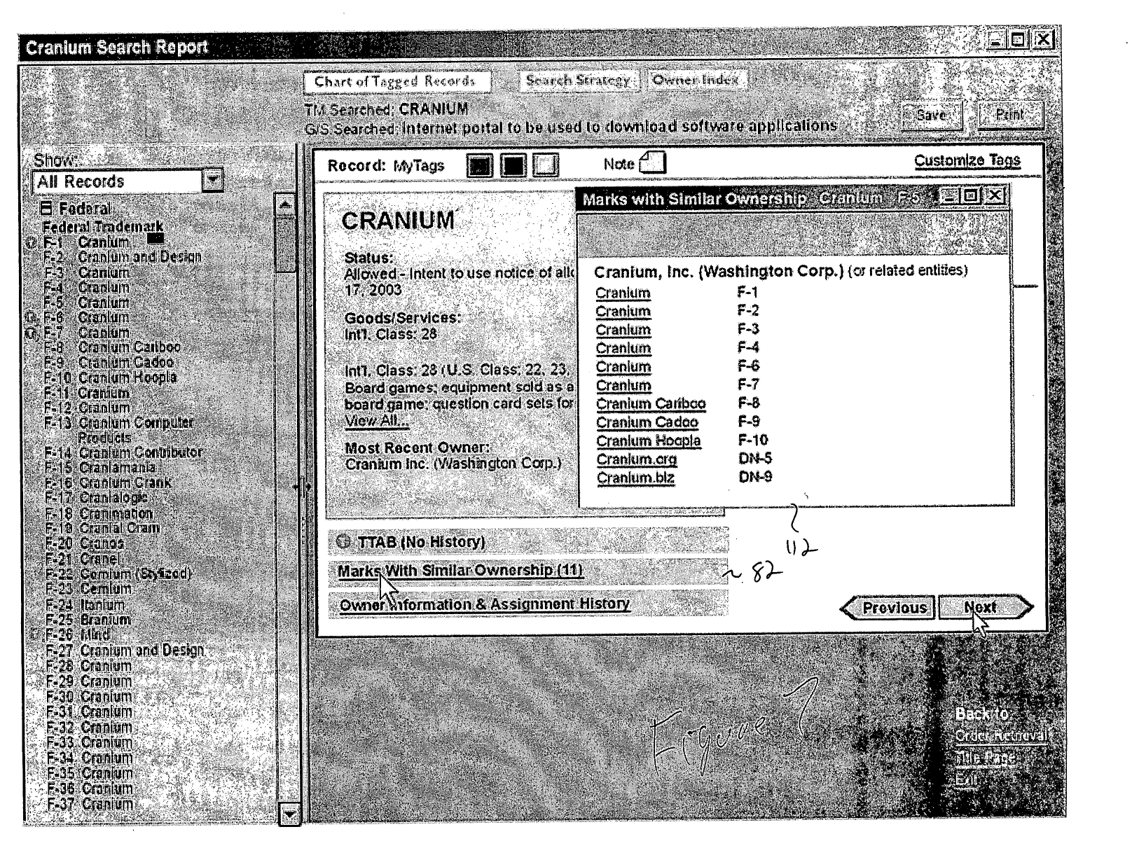

The record details 56 also provides a link 82 to marks with similar ownership (as the present record). Similar to the TTAB link 80, the link 82 itself indicates “(11)” marks are owned by a similar owner. Clicking on the link 82 will create a pop-up window 112 with further information regarding such marks, and possibly further links to additional information on such marks (e.g., a record details for each similarly owned mark). This feature is illustrated in FIG. 7 with respect to the record having reference number “F-5.”

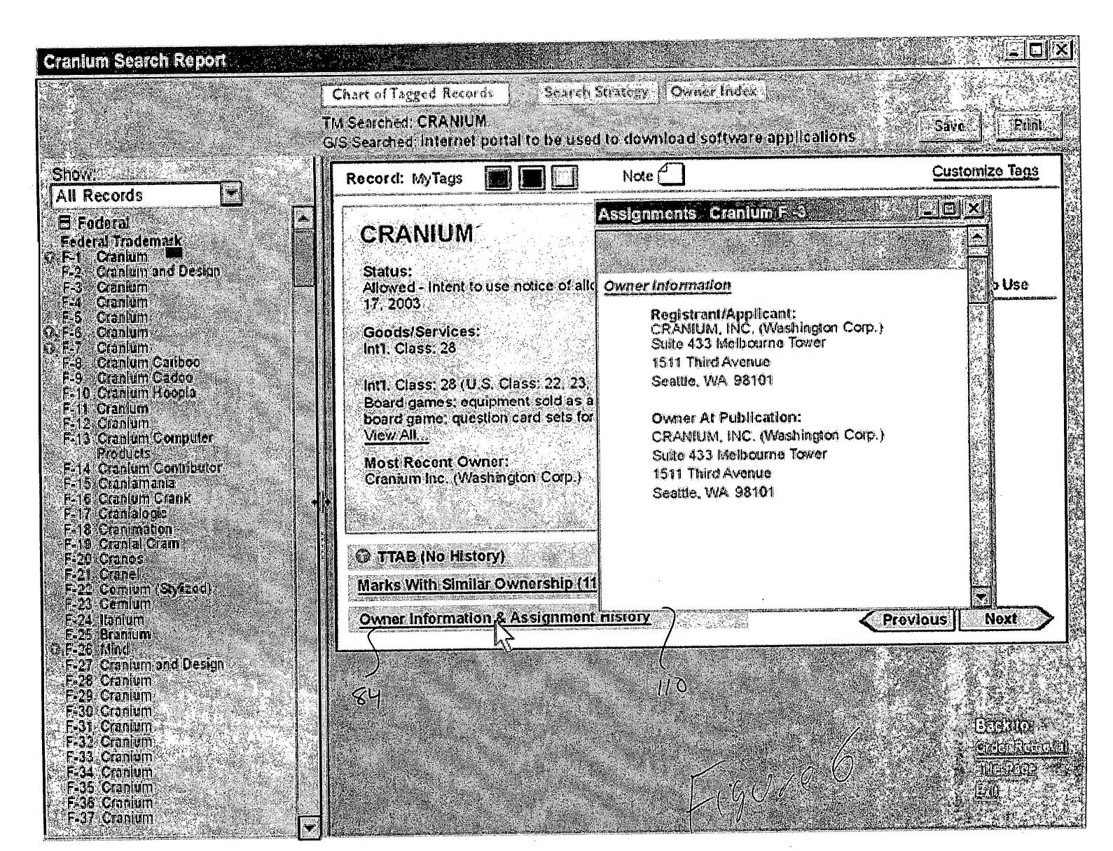

The record details 56 also includes a link 84 to the owner information and assignment history of the mark at issue in the record. Again, clicking on the link 84 opens a pop-window 110 with the relevant information as illustrated in FIG. 6 with regard to the third record having reference number “F-3.”

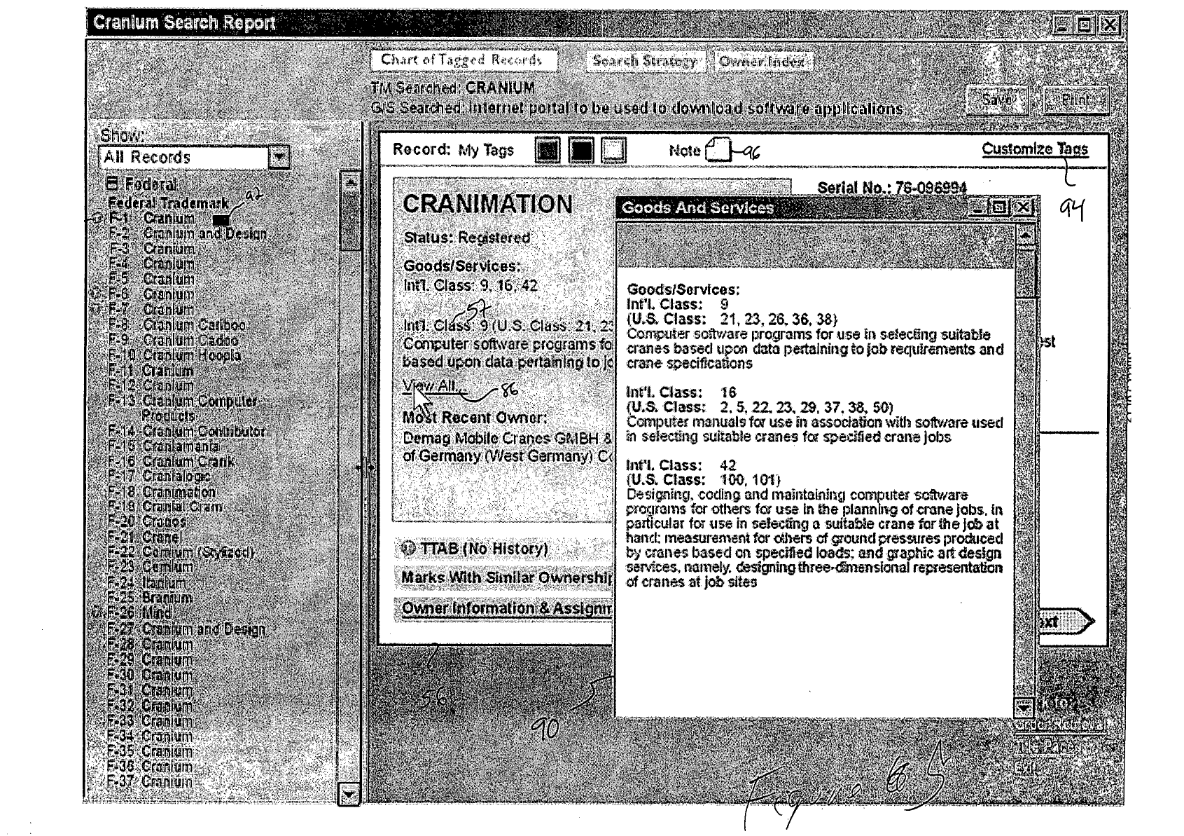

The interface 16 allows the user to collapse or expand the display of the sections or subsections of the report. The information for a particular field displayed on the screen for the record details 56 may not fit. In this instance, a “View All” link 86 is provided to link to a full field in a pop-up window anchored to the data the user is attempting to view. As illustrated in FIG. 5, the International Class information field 87 on the record details 56 includes a View All link 86 to a pop-up window 90 containing the full listing of classes. The system 2 default will be to expand all sections and subsections of a report when possible. A user can expand or collapse a section using the curser.

The system 2 allows each user reviewing a search report 48 to place a virtual tag 92 on one or more of the records 62. The tag 92 can be one of a plurality of colors (in the preferred system 2, five colors are available), wherein each color has a different significance. For example, a “red” tag may indicate an exact hit (e.g., same mark, same goods), a “yellow” tag may indicate close hit (e.g., same mark, different but similar goods), and a “blue” tag may indicate an abandoned registration. Additional colors can also be made available, and the significance given each color can be modified or changed as needed by the user.

The Navigation panel 58 displays the color(s) of the tag 92 and the initials of the user tagging the record 62 next to the last word of the mark for any tagged records 62. The color of the tags 92 will be updated in the Navigational panel 58 if the user changes the color options for the tags 92 during a review of the report 48. Only the color of the tags for the current user (i.e., the ones with the current user's initials) that changed the color options is updated. Changing the color of the tags 92 changes the colors for the current search and all unreviewed searches going forward. If the user returns to an old search, the colors will remain as they were at the time of the report review. The color of the tags 92 in searches reviewed prior to the change of colors would not be updated.

The system 2 also allows the user to customize the significance of a particular color. As shown in FIG. 4, the system includes a “Customize Tags” link 94 that can direct the user to a screen for customizing the colors. If a user places one or more tags 92 on particular records 62 and then customizes the tags 62 to different colors, the tags 62 above the record details and in the Navigation panel 58 will change color to reflect the new color selected for each option.

The preferred system 2 allows each user to place one tag 92 per record 62. Additionally, the system 2 only allows one color per tag 92. The system 2 also permits up to three (3) different users to place a tag 92 on the same record 62 (with either the same color or a different color). If a user attempts to place a tag 92 on a record 62 already having three tags 92, the system 2 will generate an error message such as “A maximum of three tags may be placed on a record.” The system 2 can be modified to increase or decrease the allowed maximum per the needs of the end users. If a record already has three tags 92, it will still allow a user to add a note or investigative information to the record 62 (as described below) without generating an error message. Moreover, such a procedure will not effect the tags 92 already placed on the record 62.

Once a tag 92 has been added to or placed on a record 62, it will appear in the color selected with the user's initials (based on retrieving information from the user's login) above the record details. It may also appear next to the last word of the trademark on the Navigation panel 58. Similarly, the user's initials may also appear with respect to a note for a record 62. In the system 2, the user's initials will only be displayed in the notes pop-up window and not on the “Added note” icon. One user will be able to view another's user's tags 92 and notes.

The system 2 allows any user to remove any tag 92 from any record 62 in a report 48. This is accomplished by clicking on the tag above the record details 56. Users cannot remove tags 92 from the Navigation panel 58. Removing a tag 92 will not remove any notes or other information added to the report 48. When one user removes another user's tag 92 from a record 48, the system will alert the user that “You are about to remove <Contact Name's> tag,” because the user will not be able to replace the tag 92 if it is removed accidentally.

If investigative information is added to a record 62 in a report 48, the system 2 automatically places a tag 92 on the record 62, using the first color as a default option. The user can change the color or remove the tag 92. Removing or clearing the tag will not remove any new information added to the record 62. If the record 62 already has the maximum three tags 92, no additional tag 92 will be added and no error message will appear.

Additionally, if additional investigative information is subsequently added to a report 48 for one or more of the plurality of records, one or more check marks (or other indicia) will appear in the record details 56 of such records. The check marks will be placed proximate the fields where the additional information was added.

As mentioned above, one or more notes can be added to any record 56 by clicking on the Note icon or link 96 at the top of the record details 56 screen. A pop-up window appears which allows the user to enter text to the note. A Clear All icon can be provided to allow a user to clear all notes attached to a record 62.

Once a note has been added to a record 62, a new Note icon will appear with the user's initials above the record details 56. Similar to adding investigative information, when a user adds a note to a record 62, the system 2 automatically places a tag 92 on the record 62. There are no limits on the number of notes that can be added to a particular record 56.

All tags 92, notes, reports, charts, etc. are saved in the background as the user reviews the search report 48 or when the user exits the search report 48. The tags and note appears on the appropriate records 62 when a user returns to the search the report 48. Additionally, an automatic bookmark function will indicate where the user is in the Navigation panel 58. When a user returns to a search report 48, the last record 62 the user viewed is highlighted and the record details 56 for that record 62 are displayed.

One purpose of the investigative information provided in each trademark search report 48 is to provide the user with the ability to create a document (e.g., an MS Word document) containing select details of the review process. The investigation information displayed in the review refers to the record 62 of the report currently selected or opened by the user of system.

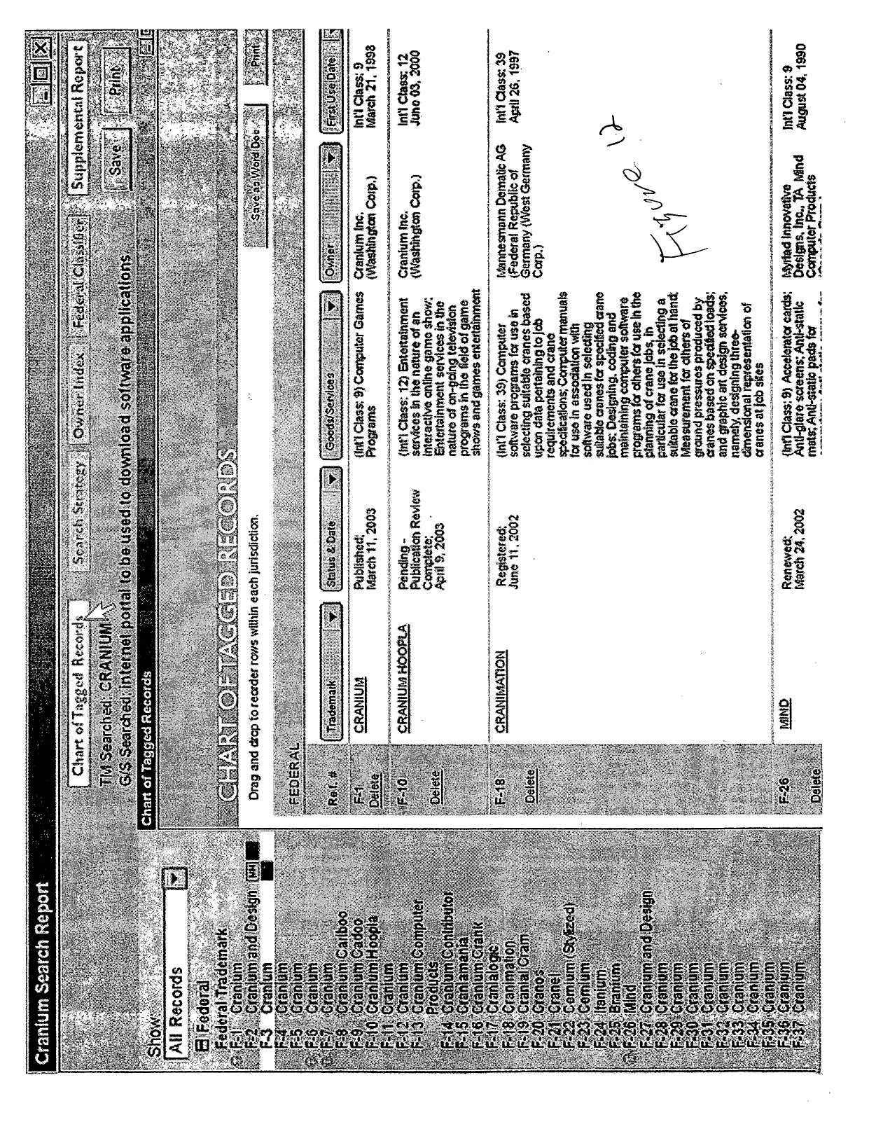

Clicking on the Chart of Tagged Records link 68 automatically filters all of the records in a report and generates a chart of only the records having one or more tags 92. The tagged records 62 appear in a separate pop-up window 100 (See e.g., FIG. 12). The chart lists the tagged records 62 and includes certain data from such records. The chart window 100 includes an icon 102 for saving the chart as a Word document. Moreover, the user can also print the chart.

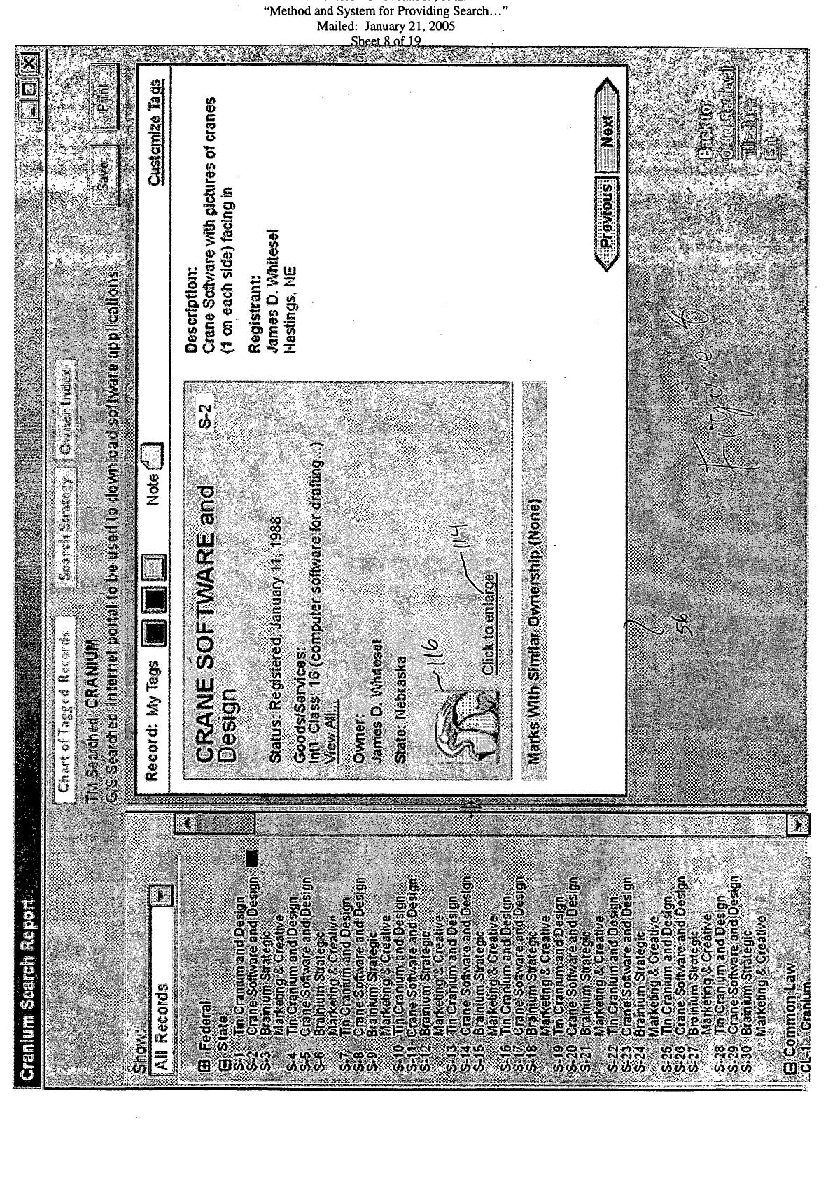

FIG. 8 illustrates a record details 56 for a State Registration of a mark “CRANE SOFTWARE” and a design. An icon or link 114 is provided to enable the user to link to and view the design. A thumbnail or partial picture 116 of the design is also provided on the record details 56.

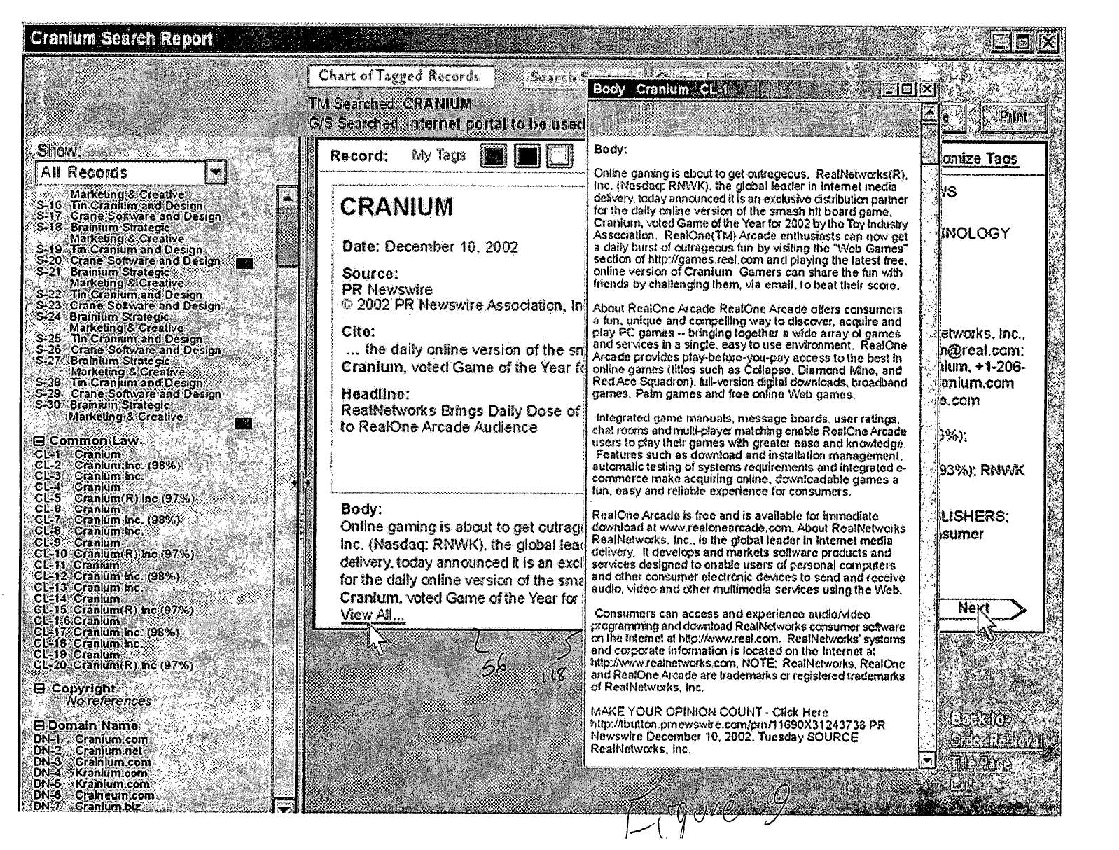

FIG. 9 illustrates a record details 56 for a Common Law mark for “CRANIUM.” A pop-up window 118 is shown with the full investigative information regarding the Body of the Source of the appearance of the mark.

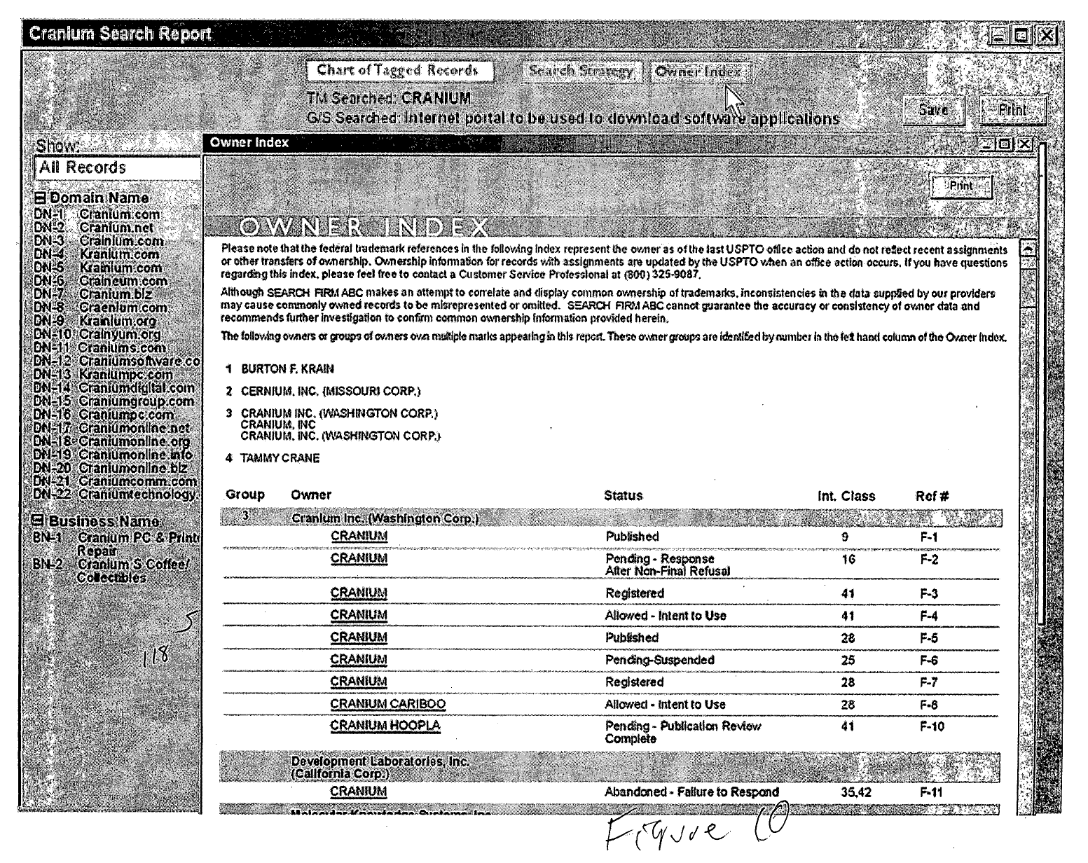

Clicking the Owner Index icon 72 opens an Owner Index window 118 as illustrated in FIG. 10. The window 118 identifies the owner of the record 56 at issue and all other marks owned by that owner.

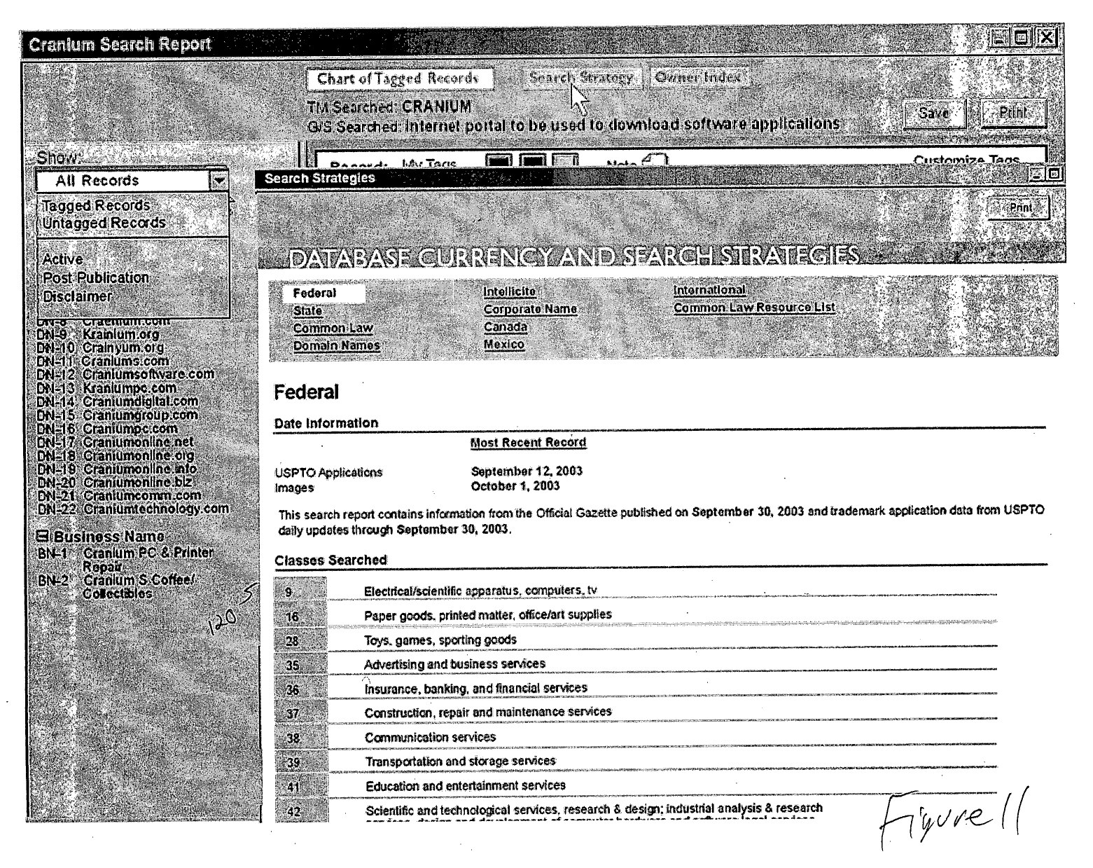

Clicking the Search Strategy icon 70 opens the Search Strategy window 120 as illustrated in FIG. 11. This window provides information regarding the search. In the example shown in FIG. 11, the window discloses classes searched in the Federal Registrar database.

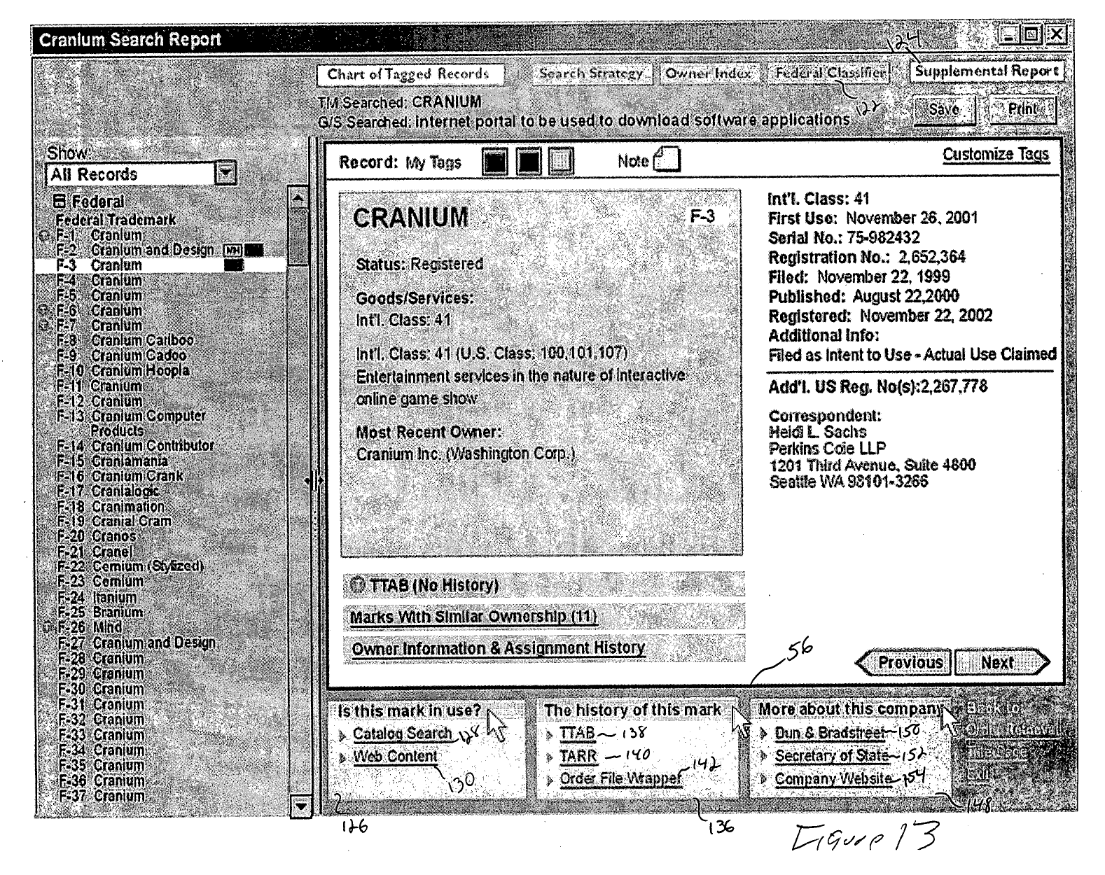

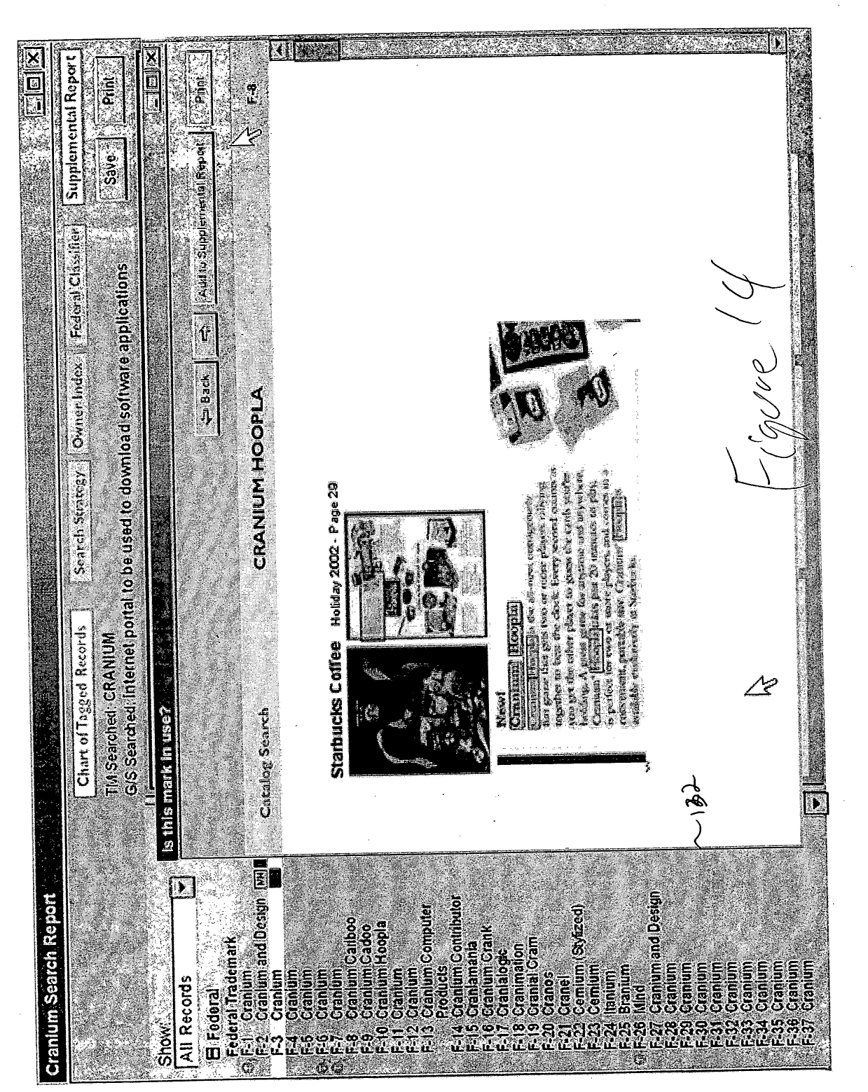

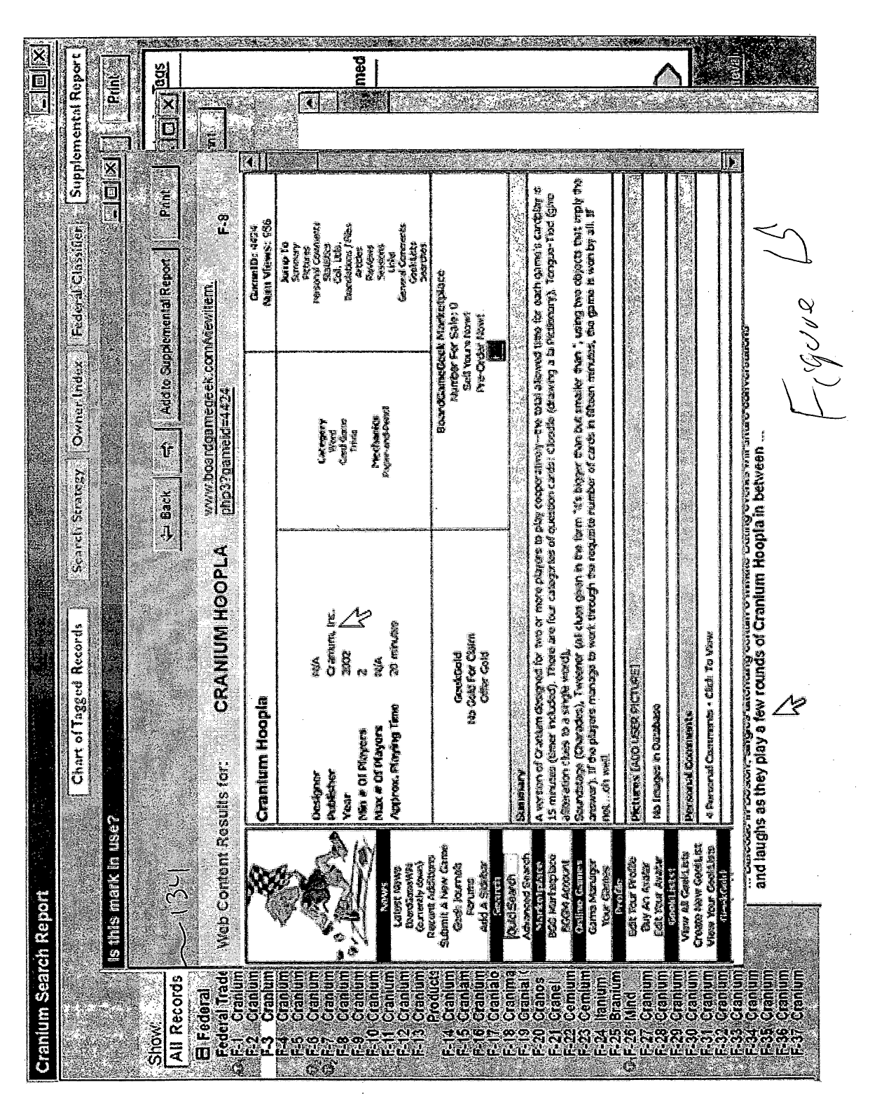

As illustrated in FIGS. 13-19, additional functionality can be provided by the system 2 for use in the review of a report 48. As shown in FIG. 13, a frame 126 is provided below the record details 56 for determining whether the mark that is the subject of the record is still in use. The frame 126 includes links for a Catalog Search 128 and a Web Content Search 130. A pop-up window 132 for the Catalog Search is shown in FIG. 14, and a pop-up window 134 for a Web Contents search is shown in FIG. 15.

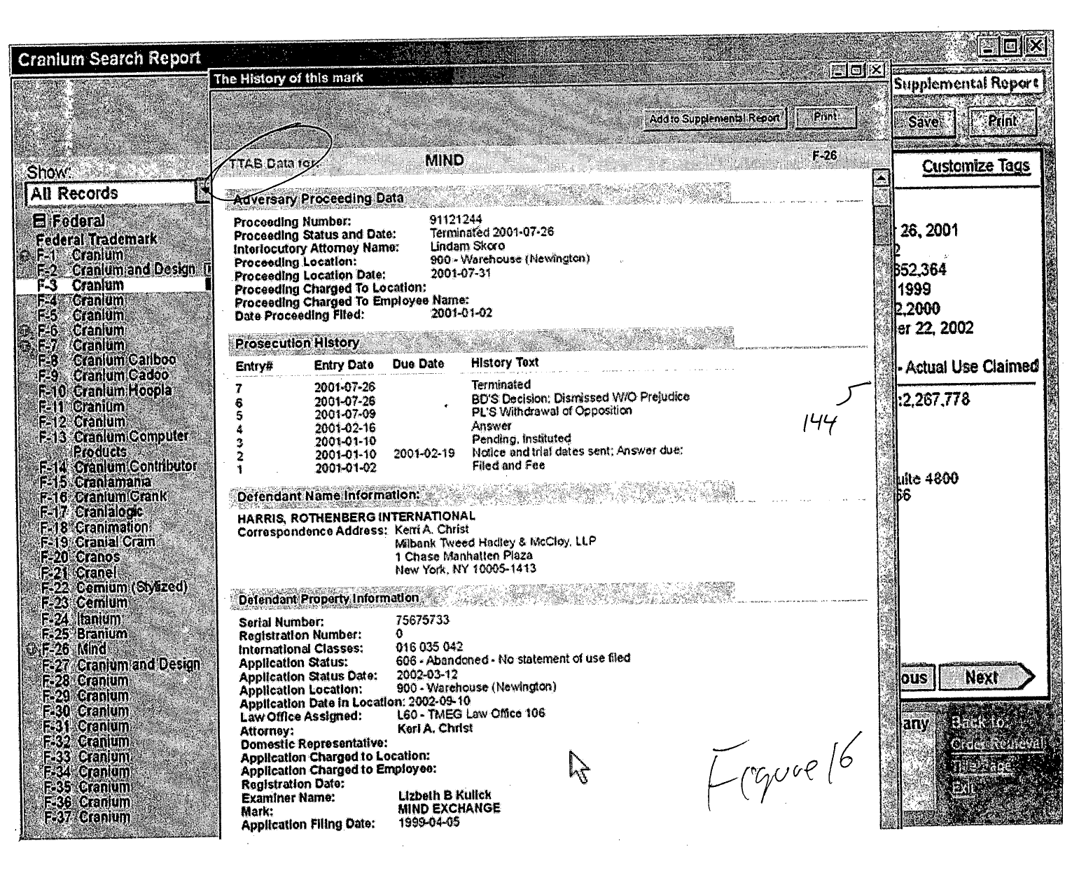

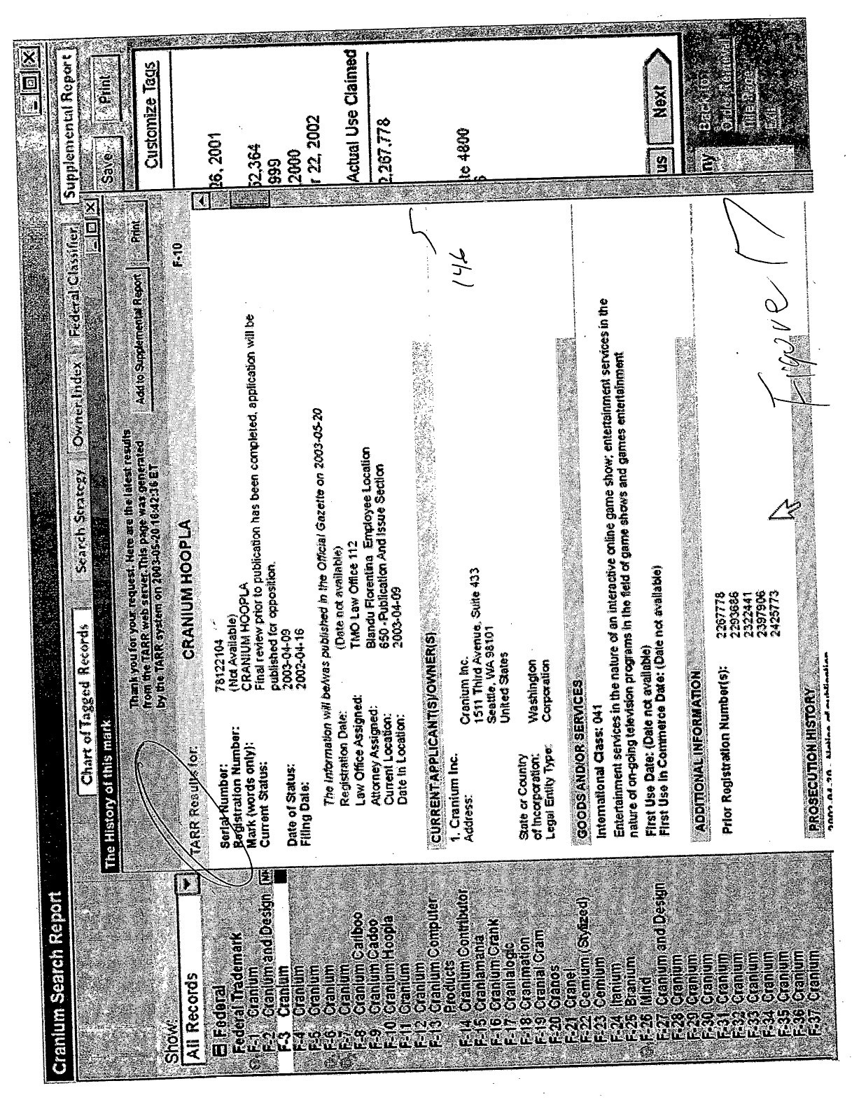

A second frame 136 below the record details 56 provides links to enable the user to obtain additional information regarding the history of the mark and in particular, the history of the Federal Registration process. Specifically, the frame 136 provides links 138, 140, 142 to the Trademark Trial and Appeal Board (TTAB), the Trademark Applications and Registrations Retrieval system (TARR), and to a service for order the File Wrapper of the Registration at issue, respectively. A pop-up window 144 showing the TTAB history of a mark is shown in FIG. 16. Similarly, a pop-up window 146 showing the TARR results for a mark is disclosed in FIG. 17.

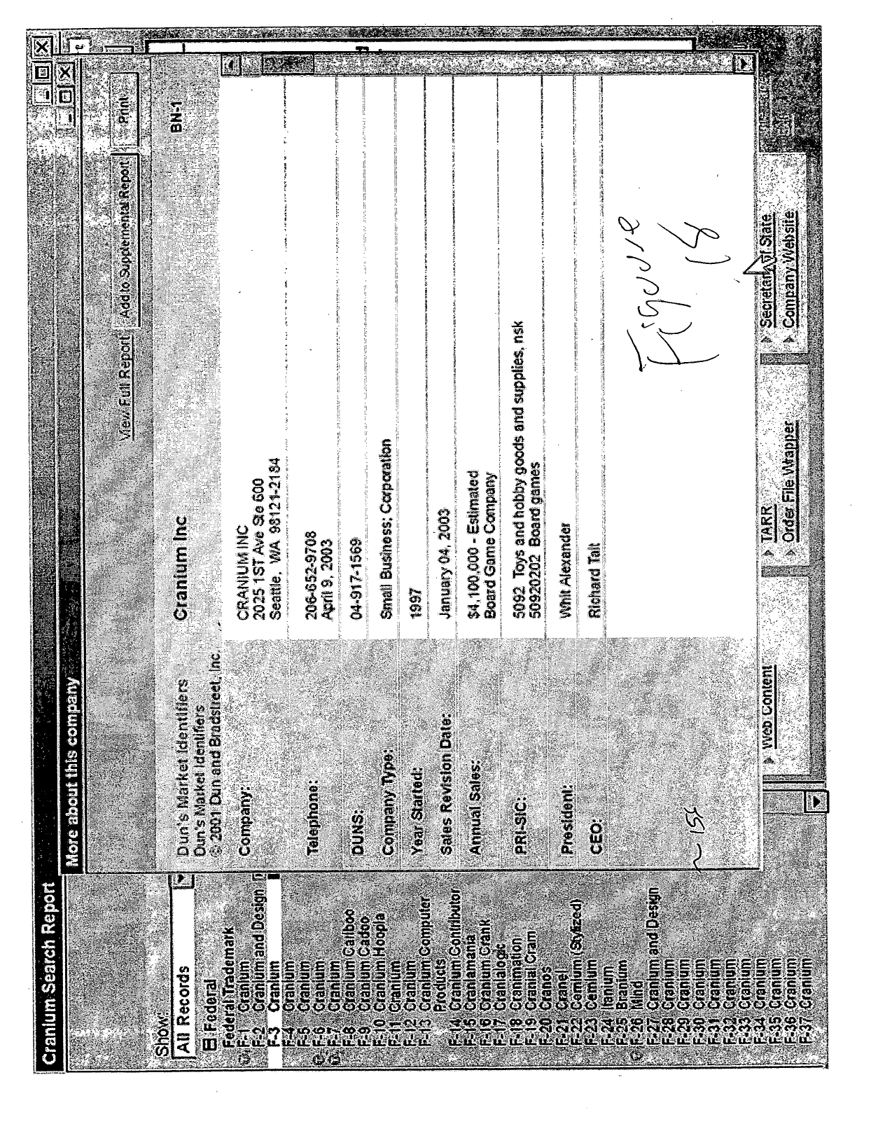

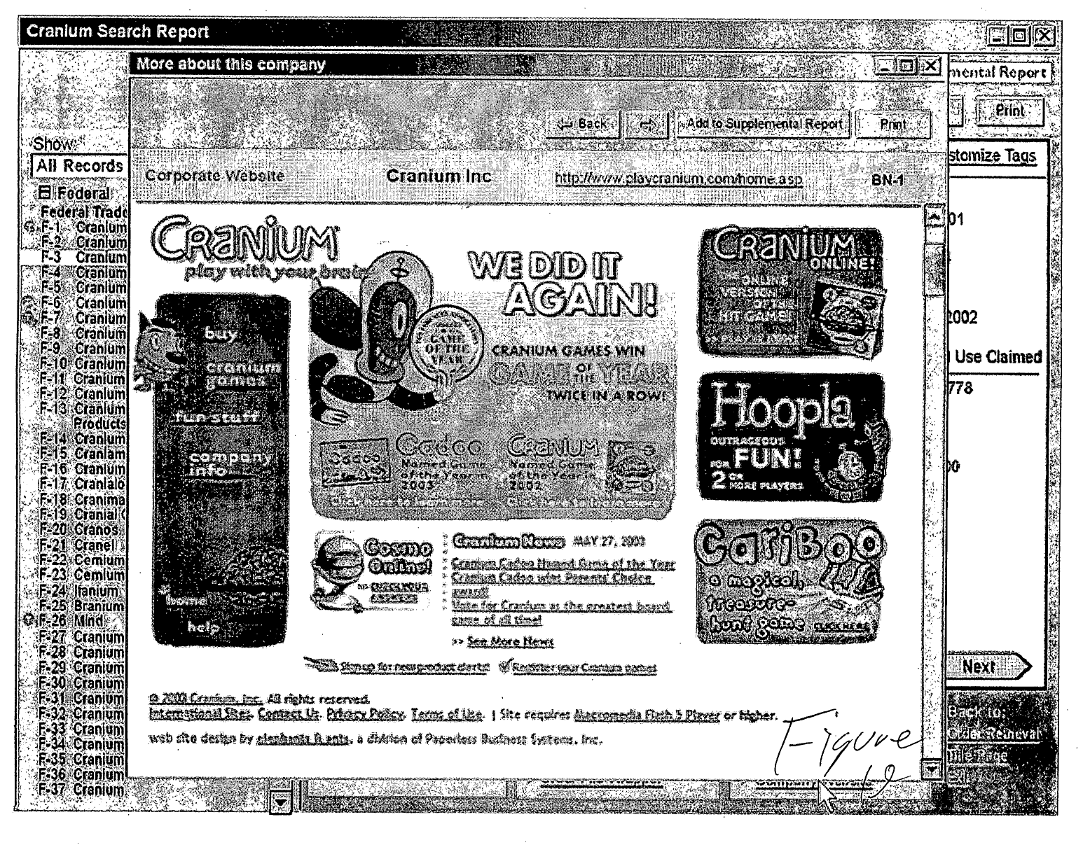

A third frame 148 below the record details 56 provides links to enable the user to obtain additional information about the company that owns the mark in the record under review. Specifically, the frame 148 provides links 150, 152, 154 to the Dun & Bradstreet® website, the Secretary of State website, and the Corporate or Company website, respectively. A pop-up window 156 showing information from a Dun & Bradstreet® report for a mark is shown in FIG. 18, and a pop-up window 158 showing the Corporate website is shown in FIG. 19.

Other functionality of the system 2 is shown and suggested in the Figures. Such functionality includes features generally common or standard to computer programs and Internet navigation, such as the ability to print, scroll, modify window sizes, a help icon, etc., as well as features that are unique or specifically associated with the review of trademark search reports, such as the various fields that are included in the examples of the record details illustrated in the Figures. It is understood that the unique computer programs or applications, and in particular—the interface for ordering, reviewing and utilizing a trademark search report, shown and described in detail herein, can be implemented by standard programming and web design techniques.

While the specific embodiments have been illustrated and described, numerous modifications come to mind without significantly departing from the spirit of the invention, and the scope of protection is only limited by the scope of the accompanying claims.

1. A system for reviewing and manipulating an electronic trademark search report comprising:
a trademark search report database having at least a first trademark search report containing a plurality of trademark records;
an interface configured to allow a first user of the system to view and navigate the first trademark search report and to place a first tag on at least a first one of the plurality of trademark records in the first trademark search report.

2. The system of claim 1 wherein the interface is further configured to allow the first user to place a second tag on a second one of the plurality of trademark records in the first trademark search report.

3. The system of claim 1 wherein the first user can select a first color from a plurality of available colors for the first tag placed on the first one of the plurality of trademark records.

4. The system of claim 3 wherein each color of the plurality of colors has a unique significance.

5. The system of claim 3 wherein the first user can change the first tag to a second color of the plurality of available colors.

6. The system of claim 1 wherein the first one of the plurality of trademark records in the first trademark search report comprises a link to additional information relating to the first one of the plurality of trademark records in the first trademark search report.

7. The system of claim 6 wherein the additional information includes a design of a mark identified in the first one of the plurality of trademark records.

8. The system of claim 6 wherein the additional information includes registration information of a mark identified in the first one of the plurality of trademark records.

9. The system of claim 1 wherein each trademark record comprises a plurality of record sections and wherein the interface is configured to allow the first user to one of expand and collapse each of the plurality of record sections.

10. The system of claim 1 wherein the interface is further configured to allow a second user of the system to view and navigate the first trademark search report and to place a second tag on the first one of the plurality of trademark records in the first trademark report.

11. The system of claim 10 wherein the second user can select a first color from a plurality of available colors for the second tag placed on the first one of the plurality of trademark records.

12. The system of claim 1 wherein initials of the first user are placed on the first tag.

13. The system of claim 10 wherein initials of the second user are placed on the second tag.

14. The system of claim 1 wherein the interface is further configured to allow the first user to place a note on the first one of the plurality of trademark records.

15. The system of claim 1 wherein the first user accesses the first trademark search report and interface over a network through a browser application.

16. The system of claim 15 wherein the network is the Internet.

17. The system of claim 1 wherein the interface is further configured to allow the first user to filter for display a subset of trademark records of the plurality of trademark records wherein each of the trademark records in the subset includes a tag.

18. The system of claim 17 wherein the tag for each trademark record in the subset of trademark records is the same color.

19. The system of claim 16 wherein the trademark search report database includes a plurality of trademark search reports, and the interface allows the first user to select a trademark search report from the plurality of trademark search reports as the first trademark search report.

20. A system including a database accessible by a user's computer over a network for reviewing and manipulating trademark search reports comprising:
a host computer accessible to a plurality of devices over a network, the host computer coupled to a database storing a plurality of trademark search reports wherein each trademark search report includes a plurality of trademark records, the host computer including an application for generating a user interface to allow a user of the system on a remote device to select, display and navigate through the plurality of trademark search reports and the plurality of trademark records associated with each trademark search report, the user interface allowing a user to place a first color coded tag on a first trademark record of the plurality of trademark records in a first trademark search report of the plurality of trademark search reports.

21. The system of claim 20 wherein the user interface allows the first user to place a second color coded tag on a second trademark record of the plurality of trademark records in a first trademark search report of the plurality of trademark search reports.

22. The system of claim 20 wherein the first user can generate a first note associated with the first record.

23. The system of claim 22 wherein the first user can generate a second note associated with a second record of the plurality of records of the first trademark search report.

24. An online electronic system for reviewing a trademark report, the system and trademark report being accessible to multiple users, the system comprising:
a server computer having a processor coupled to a database containing a first trademark report having a plurality of records, the server computer connected to the Internet and accessible to a plurality of user computers connected to the Internet; and,
a user interface application supported by the server computer that allows a first user through a first user computer to review the first trademark report and to place a virtual tag on a first record of the plurality of records in the first trademark report.

25. The system of claim 24 wherein the interface application allows the first user to place a second tag on a second record of the plurality of records.

26. The system of claim 25 wherein the interface application allows the first user to place a plurality of additional tags on a respective plurality of additional records in the report.

27. The system of claim 25 wherein the interface application allows the first user to select a first color for the first tag.

28. The system of claim 27 wherein the interface application allows the first user to select a second color for the second tag.

29. The system of claim 24 wherein the interface application allows a second user to review the first trademark report and to place a first virtual tag on the first record of the plurality of records in the first trademark report.

30. The system of claim 29 wherein the interface application allows the second user to place a second tag on a second record in the report.

31. The system of claim 24 wherein the interface application allows the first user to place a first note associated with the first record in the report.

32. A method of electronically reviewing a trademark search report stored in a database comprising:
supporting a website accessible to a plurality of users over a network;
maintaining a plurality of trademark search reports;
receiving input from a first user computer of a first user of the system selecting a first trademark search report containing a plurality of records;
generating an electronic signal for displaying the first trademark search report on the first user computer;
receiving input from the first user computer identifying a first record of the plurality of records in the first trademark report for placement of a first tag; and,
generating a first tag for displaying in connection with the first record.

33. The method of claim 32 further comprising the step of:
receiving input from the first user computer selecting a color of the first tag.

34. The method of claim 32 further comprising the step of:
receiving input from a second user computer of a second user of the system selecting the first trademark search report;
generating an electronic signal for displaying the first trademark search report on the second user computer;
receiving input from the second user computer identifying the first record of the plurality of records in the first trademark report for placement of a second tag; and,
generating a second tag for displaying in connection with the first record.

35. The method of claim 32 further comprising the steps of:
receiving input from the first user computer identifying a plurality of additional records from the plurality of records in the first trademark report for placement of a respective plurality of tags;
filtering the plurality of records for records having tags; and,
creating a chart of the filtered records.
